(19) United States
(12) Patent Application Publication
(10) Pub. No.: US 2007/0283990 A1
(43) Pub. Date: Dec. 13, 2007

(54) CONVERTIBLE WHEELCHAIR AND WALKER

(76) Inventors: Felix L. Fernandez, Port St. Lucie, FL (US); Michael J. Klautky, Port St. Lucie, FL (US)

Correspondence Address: FELDMANGALE, P.A., ONE BISCAYNE TOWER , 30TH FLOOR , 2 SOUTH, BISCAYNE BOULEVARD, MIAMI, FL, 33131-4332, US

(21) Appl. No.: 11/761,899

(22) Filed: Jun. 12, 2007

Related U.S. Application Data
(60) Provisional application No. 60/813,011, filed on Jun. 12, 2006.

(51) Int. Cl. A61H 3/00; B62M 1/00

(52) U.S. Cl. 135/67; 280/87.041

(57) ABSTRACT

A convertible wheelchair and walker having a frame constructed of two front legs connected to each other by upper and lower front cross members, each cross members having a u-shape that is affixed to the front legs by a bracket attached to the arms of the cross member and front legs, and two rear legs pivotally connected to the front legs and connected to each other by at least one upper rear cross member also having a u-shape and affixed to the rear legs by a bracket attached to the arms of each cross member and rear leg. Two front wheels are attached to the front legs which are curved forward to elongate the frame and provide increased stability. Two rear wheels attached to the rear legs, and footrests are attached to the front legs.

### BACKGROUND OF THE INVENTION

This application claims priority from U.S. application Ser. No. 60/813,011 filed Jun. 12, 2006. The present invention relates to improvements in the design and operation of existing wheelchair and wheeled walker devices. Specifically, the invention relates to an improved wheeled walker construction of the type including a light-weight and foldable frame which can be efficiently adjusted to conform to the specific user.

Wheelchairs and wheeled walker devices are relatively well known in the art to include interconnected frame components having a seat structure and seat back mounted thereon, with the frame components being supported for rolling movement by wheels. The interconnected frame components are also often adapted for folding to facilitate between a collapsed position that is ideal for storage and shipment, and an unfolded or expanded position for normal use. In many wheeled walker devices, various structural adjustment features are also provided to meet the particular needs of the individual using the device. Some structural adjustment features include a seat back attached to the front of the device that allows the user to sit down at certain times when they are not using the walker.

What is needed is a device that incorporates the advantages of an adjustable wheeled walker device with the advantages of a care-giver assisted wheelchair. The object of the present invention is to combine these advantages by incorporating a patient's ability to independently ambulate with the ability to be transported by the care-giver comfortably and safely.

### SUMMARY OF THE INVENTION

The present invention was designed and developed initially for the medical equipment industry, but various related industries can benefit from it. The present invention is essentially a walker assist device, but also allows for the patient to easily and efficiently be transported by a care-giver, without the need of a separate transporting device. Thus, the device is a true hybrid in the sense that it combines a dual walker assist and a care-giver assisted transporting function in one ergonomically designed device. This allows the patient greater flexibility and independence than previously available.

In one embodiment, the device improves on existing medical devices by arching the front legs of the device's frame, effectively increasing the distance between the device's center of gravity and the front wheels of the device. This front forward extension of the frame stabilizes the device and prevents forward tipping of the patient when the device is pushed from the rear by a care-giver. The device also allows for safe and comfortable footrests in the transport mode. The footrests can also be folded and removed when the device is not in the transport mode.

Another ergonomic feature of the device is a removable, curved backrest made of a strong and flexible fabric, plastic, or other suitable material, which can be positioned to accommodate the patient in the transport or walker mode. The backrest limits patient fatigue, and allows for prolonged usage in the sitting position while the patient is alone or in transport mode with a care-giver.

To achieve optimal light weight to strength and safety ratio for the device, the device's frame is preferably constructed with a light-weight anodized aluminum already in existence for medical walker or transporter devices with proven safety profiles. The device's seat is preferably constructed using a rigid plastic base with an overlaid soft foam rubber cushion.

The device incorporates a brake and locking system to the rear wheels similar to existing designs in the industry. This combined braking and locking system may be supplemented with hand-held control levers for use by a patient in the walker mode, or by a caregiver in the transport mode, although any of a number of existing brake designs can be used. In another embodiment, the device uses a collapsible hinge mechanism that allows anterior/posterior directional ease of folding via a handle fixed below the seat. The device can be folded from an 85 degree open position to a 5 degree closed or folded position, and stowed away comfortably with minimal obtrusion.

### BRIEF DESCRIPTION OF THE DRAWINGS

FIG. 1 is a perspective view of the convertible wheelchair and walker of this invention.

FIG. 2 shows another embodiment of the invention in perspective view.

FIG. 3 is a view of the invention that includes a seat back.

FIG. 4 shows an embodiment in which the seat back has been reversed.

### DETAILED DESCRIPTION OF THE PREFERRED EMBODIMENTS

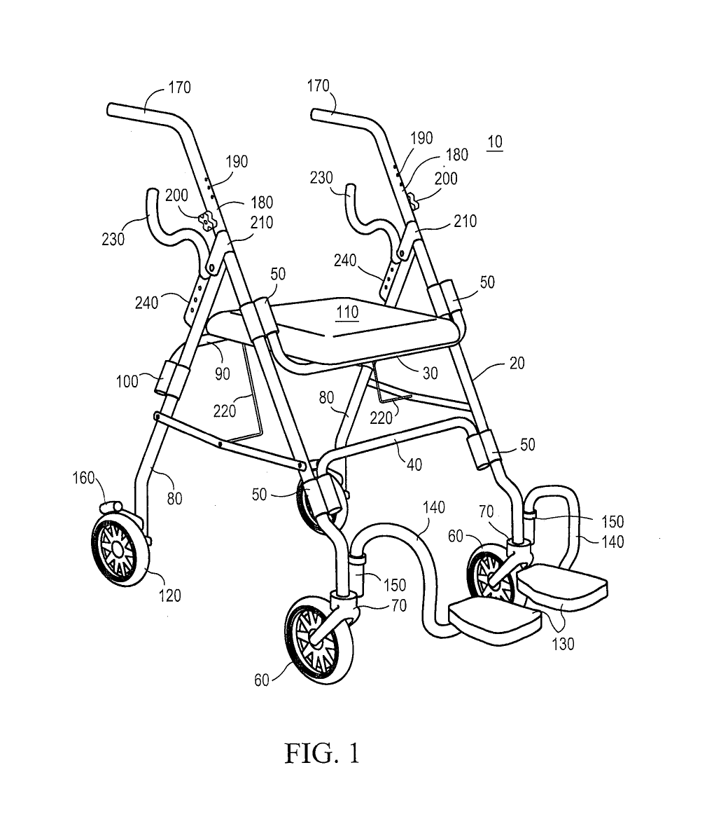

A convertible wheelchair and walker 10, shown in FIG. 1, has a collapsible frame and combines a dual walker assist and transporting function into one ergonomically designed device. In one embodiment, the frame is constructed of tubular, light-weight anodized aluminum or any equivalent thereof that is known in the art and is currently used by medical walker and/or transporter devices with proven safety profiles. In another embodiment, the weight of the device's frame does not exceed fifteen pounds.

As shown in FIG. 1, the device's frame consists of two front legs 20 connected to each other by upper 30 and lower 40 cross members. Each cross member has a u-shape, and is affixed to each respective front leg by brackets 50 welded to the arms of the cross members 30, 40 and the two front legs 20. Two front wheels 60 are attached to the lower ends of each front leg 20 by rotary bearings and casters 70, allowing the front wheels to rotate about a 360 degree axis. Two rear legs 80 are pivotally connected to the front legs 20 and form an a-frame structure with the front legs when the device is in an open position. The two rear legs are connected to each other by at least one rear cross member 90. Rear cross member 90 has a u-shape and is affixed to each respective rear leg by brackets 100 that are welded to the rear legs 80.

Brackets on the 50, 100 on the front and rear legs 20, 80, respectively, can be configured with through holes to accept pins, thereby permitting the upper front and the rear cross members to be adjusted in height. A seat 110 rests upon rear cross member 90 and front upper cross member 30, and is attached to rear cross member 90 with tubular brackets fastened to the underside of the seat and clamped to the tubular upper rear cross member 90, permitting the seat to rotate about the cross member and be tilted upward to a near-vertical position when the device is folded. The seat is generally a rectangular or square planar configuration, and in one embodiment is made of a rigid plastic base with an overlaid soft foam rubber cushion.

In the embodiment shown in FIG. 1, the seat can be raised or lowered by vertically adjusting rear cross member 90 and front upper cross member 30 in their respective brackets 100, 50. Two rear wheels 120 are attached to the lower ends of each rear leg and are fixed for non-swivel rotation by an axle.

Conventional ergonomic footrests 130 are attached to the front legs. The footrests are attached to the device by two s-shaped support members 140 that can be inserted into two respective tubular receptors 150 that are welded to the front legs 20. The ends of the s-shaped support members contain a conventional spring loaded lock and release mechanism that can be depressed when inserted into the tubular receptor 150. The tubular receptor has several apertures that will allow the lock and release mechanism to protrude through the aperture thereby locking the footrest support members into place at a desired height. Depressing the loaded lock and release member and pulling the s-shaped support member completely out of the tubular receptor allows for the removal of the footrest altogether. In another embodiment, the footrests can be adapted for swing-out movement to out-of-the way positions, as known and described by those skilled in the art, with appropriate latch structures being provided for releasably locking the footrests and support members in the normal operational positions.

A brake and locking system 160 is attached to the rear wheels. The brake system can be actuated in any of a number of ways, from hand grips mounted on the handles to a foot actuated lever mounted at the rear wheels. Such mechanisms are conventional and are not shown in the drawings. In either case, actuating the mechanism will cause a metal bar to impinge upon the outer surface of each respective rear wheel 120. When the brake is locked, the device will be prevented from rolling, and will remain stationary while a person using the transporter can be seated or can rise from a seated position.

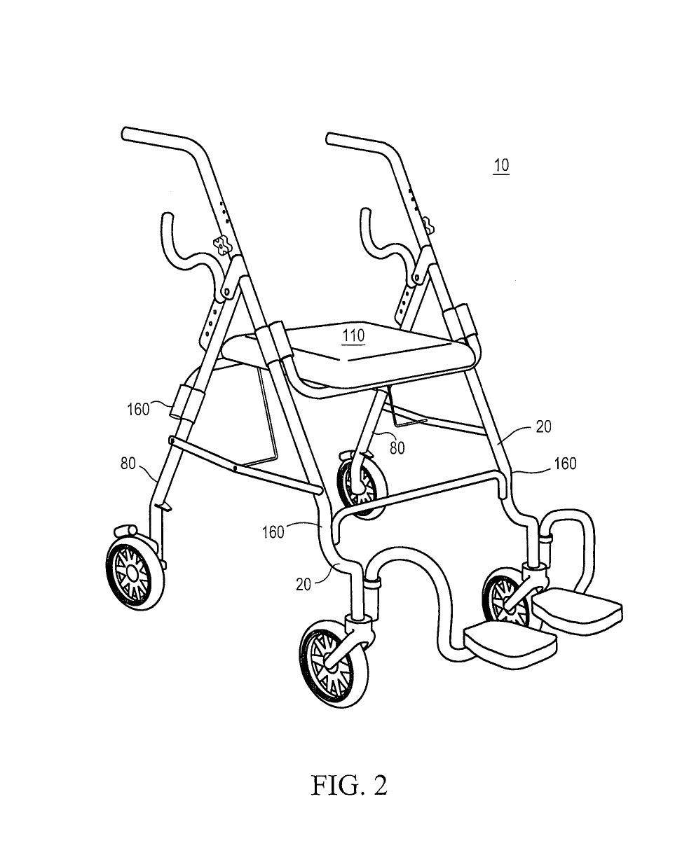

In the embodiment depicted in FIG. 2, cross member 90 is attached to rear legs 80, and lower front cross member is attached to front legs 20, with weld joints 260. In this embodiment, the height of the seat 110 on the rear legs cannot be adjusted because the height of the rear cross member is fixed, although some adjustment of the upper front cross member will permit small adjustments in seat height and angle. This embodiment may be less expensive to manufacture, and may be suitable for some markets and uses, although the height adjustment of the seat is limited.

Two hand grip extensions 170 are inserted into the upper ends 180 of the front legs 20. In one embodiment the extensions are separable from the front legs and contain several apertures 190 which can be engaged at different height locations by respective bolts retained by washers and nuts, each encased in large and easily turned triangular or x-shaped handles 200.

In another embodiment, each front leg is also connected to its respective rear leg by a hinged arm 210. The center of each hinged arm is connected to the distal end of a respective l-shaped member 220. The other end of each L-shaped member is secured to the underside of the seat 110. When the seat is lifted, each L-shaped member 220 pulls up the hinged arms 210, forcing the rear legs 80 to pivot towards the front legs 20 in a closing motion. Once the rear legs contact the front legs the device is in a closed position. In another embodiment, the device can be folded from an angle between the front and real legs of 85 degrees in the open position to an angle of 5 degrees in the closed position, and stowed away comfortably for minimal obtrusion.

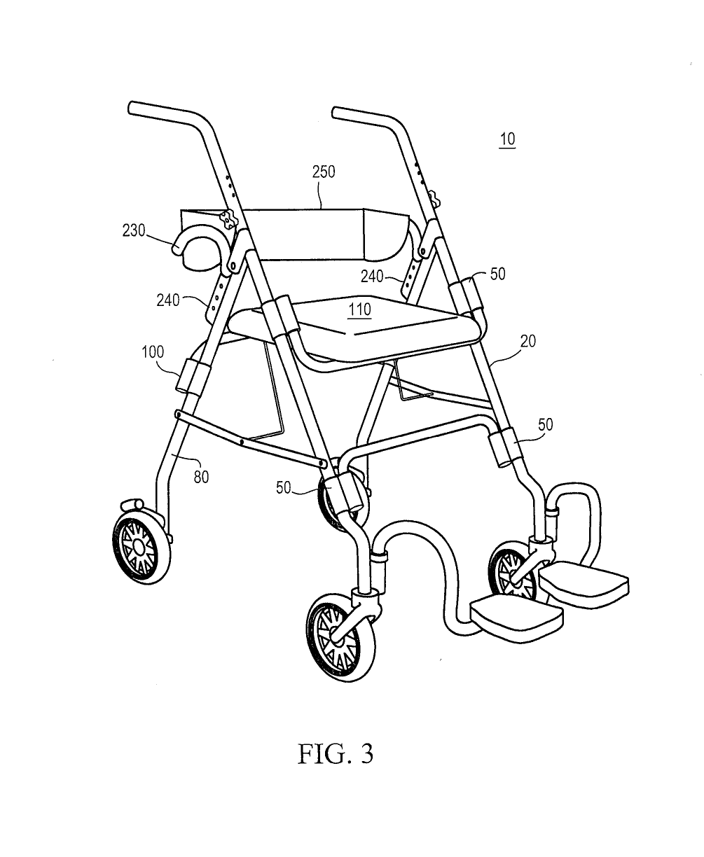

As shown in FIG. 3, another embodiment includes a seat back 250 made of a strong and flexible fabric, plastic, or other suitable material that can be positioned to accommodate the patient in the transport or walker mode. The seat back is attached to the device by two s-shaped support members 230 that can be inserted into two respective tubular receptors 240 that are welded to the rear legs. The ends of the s-shaped members 230 contain a conventional spring loaded lock and release mechanism that can be depressed when the support member is inserted into the tubular receptor 240. The tubular receptor has several apertures that will allow the lock and release mechanism to protrude through the aperture thereby locking the seat back into place at a desired height. Depressing the spring loaded lock and release member and pulling the s-shaped mechanism completely out of the tubular receptor allows for the removal of the seat back altogether.

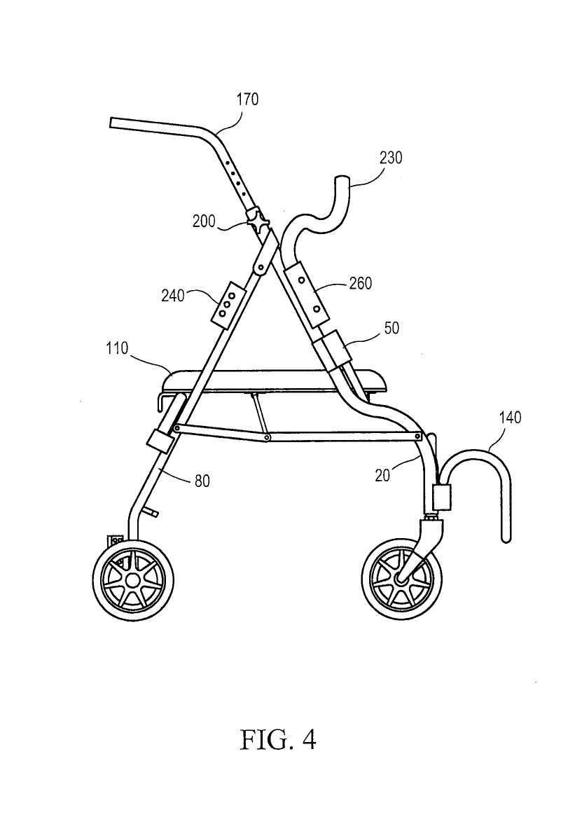

In another embodiment shown in FIG. 4, the s-shaped seat back support members 230 are inserted into two tubular receptors 260 welded to the front legs 20. In this configuration, a person using the device as a walker can simply turn around and sit down, facing rearward, without having to walk around the device to sit in it facing forward. When s-shaped support members 230 are attached to the rear legs 80, the patient can sit facing the front of the device thus allowing the care-giver to push the patient from behind, as in a conventional wheel chair.

In order to prevent inadvertent front tip-over of the device when it is being pushed from behind, or when a person seated in the chair leans forward as if to adjust the foot rests or pick up something on the ground, the front legs 20 are curved and extended frontally 260 at the base of the front wheels. By elongating the frame by 10%-20%, the distance from the front wheels to the center of gravity of the device and passenger is increased, thereby providing greater stability to the device and preventing the passenger from tipping forward.

What is claimed is:

1. A convertible wheelchair and walker assembly comprising:
a frame comprising two front legs, each of said front legs being connected to the other with upper and lower front cross members, each said cross member having a u-shape and two arms, each said arm of each said front cross member being affixed to one of said front legs by a bracket attached to said arm and to said front leg;
two rear legs each pivotally connected to one of said front legs and being connected to each other by at least one upper rear cross member, said upper rear cross member having a u-shape and two arms and being affixed to each of said rear legs by brackets such that each said bracket is attached to one of said arms and to one of said rear legs;
a front wheel attached to each of said front legs;
a rear wheel attached to each of said rear legs;
a footrest attached to each of said front legs;
a seat pivotally connected to said rear cross member and being supported by said upper front cross member and being upwardly rotatable about said rear cross member;
two hand grip extensions connected to the upper ends of said front legs;
a seat back supports attached to said rear legs,
said two front legs being curved forwardly above said front wheels.

2. A convertible wheelchair and walker assembly as recited in claim 1 wherein said frame is constructed of a tubular, light-weight anodized aluminum.

3. A convertible wheelchair and walker assembly as recited in claim 2 wherein said frame does not exceed fifteen pounds in weight.

4. A convertible wheelchair and walker assembly as recited in claim 1 wherein said front wheels are attached to said front legs by rotary bearings and casters, whereby said front wheels can rotate in a 360 degree arc.

5. A convertible wheelchair and walker assembly as recited in claim 4 wherein said rear wheels are fixed for non-swivel rotation by an axle.

6. A convertible wheelchair and walker assembly as recited in claim 1 wherein said foot rests attach to said front legs by two s-shaped foot rest support members inserted into tubular receptors attached to said front legs.

7. A convertible wheelchair and walker assembly as recited in claim 6 wherein the ends of said s-shaped foot rest support members are comprised of a spring loaded lock and release mechanism that can be depressed when inserted into said tubular receptor, said tubular receptor having several apertures allowing said lock and release member to protrude through said apertures and lock said footrest units into place at a desired height.

8. A convertible wheelchair and walker assembly as recited in claim 7 whereby depressing said spring loaded lock and release mechanism and pulling said s-shaped support member completely out of said tubular receptor allows for removal of said footrest.

9. A convertible wheelchair and walker as recited in claim 1 wherein said footrests are adapted for swing-out movement to out-of-the way positions.

10. A convertible wheelchair and walker as recited in claim 1 wherein said seat is a rectangular or square planar configuration.

11. A convertible wheelchair and walker as recited in claim 10 wherein said seat is made of a rigid plastic base with an overlaid soft foam rubber cushion.

12. A convertible wheelchair and walker as recited in claim 11 wherein said seat height is adjustable.

13. A convertible wheelchair and walker as recited in claim 1 wherein said extensions contain several apertures which can be engaged at different height locations by respective bolts retained by washers and nuts, each encased in large and easily turned handles.

14. A convertible wheelchair and walker as recited in claim 1 wherein said front legs are connected to said rear legs by a hinged arm.

15. A convertible wheelchair and walker as recited in claim 14 wherein the center of said hinged arm is connected to the distal end of an L-shaped member, and the other end of said L-shaped member is secured to the underside of said seat.

16. A convertible wheelchair and walker as recited in claim 15 wherein pulling upward on said handle of said seat causes said L-shaped members to pull up said hinged arms forcing said rear legs to pivot towards said front legs.

17. A convertible wheelchair and walker as recited in claim 1 wherein said seat back is made of a fabric.

18. A convertible wheelchair and walker as recited in claim 17 wherein said seat back is attached by s-shaped support members inserted into two tubular receptors welded to said rear legs.

19. A convertible wheelchair and walker as recited in claim 18 wherein the ends of said s-shaped support members are comprised of a spring loaded lock and release mechanism that can be depressed when inserted into said tubular receptor and said tubular receptor has several apertures where said lock and release mechanism can protrude through said apertures and lock said seat back into place at a desired height.

20. A convertible wheelchair and walker as recited in claim 19 whereby depressing said spring loaded lock and release mechanism and pulling said s-shaped support member completely out of said tubular receptor allows for removal of said seat back.

21. A convertible wheelchair and walker as recited in claim 19 whereby said s-shaped support members attaching the seat back are inserted into two tubular receptors welded to said front legs.
